(19) United States
(12) Patent Application Publication
(10) Pub. No.: US 2005/0270770 A1
(43) Pub. Date: Dec. 8, 2005

(54) Convenience light

(76) Inventors: Mary J. Warrender, Valencia, CA (US); Michael A. Hackelberg, Santa Clarita, CA (US); David L. Hendrickson, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 11/133,107

(22) Filed: May 19, 2005

Related U.S. Application Data
(60) Provisional application No. 60/572,399, filed on May 19, 2004.

(51) Int. Cl. F21L 2/00

(52) U.S. Cl. 362/157

(57) ABSTRACT

A convenience light for illuminating small interior spaces of enclosures, such as furniture, chests, jewelry boxes and the like, has a battery powered LED lamp. A mechanical or magnetic switch device is used to automatically turn on and off the LED by opening and closing the movable member (drawer, door, etc.) of the enclosure. The low power consumption LED provides lengthy continuous use of the light with a tiny watch battery. The LED and watch battery allow the housing to have a small form factor for discrete placement in the enclosure at various positions. In variations forms, the device can include a reflective surface at the exterior of the housing adjacent the lamp and a mechanism to articulate the lamp to direct the light in a specific direction.

### CROSS-REFERENCE TO RELATED APPLICATIONS

This application claims benefit to U.S. Provisional Application No. 60/572,399, filed May 19, 2004.

### STATEMENT OF FEDERALLY SPONSORED RESEARCH OR DEVELOPMENT

Not applicable.

### BACKGROUND OF THE INVENTION

1. Technical Field

The present invention relates to lighting devices, and in particular to convenience lights for illuminating interior spaces in furniture, cabinets, chests, lockboxes and other such enclosures.

2. Description of the Related Art

Various lighting devices have been devised to illuminate the small interior spaces of file cabinets, desk drawers, tool chests, jewelry boxes and the like. Many of these devices automatically turn on the light as the enclosure is opened and then turn off the light when the enclosure is closed. U.S. Pat. No. 5,246,285, for example, discloses such a light in which a cam switch is engaged or disengaged with the contacting surface of the enclosure to control operation of the light. Other switching mechanisms include a magnetic switch, such as in U.S. Pat. No. 4,872,095 for lighting a doorway, a spring-biased mechanical switch, as in U.S. Pat. No. 4,442,478, a ball accelerometer piezoelectric switch, as in U.S. Pat. No. 6,060,835, and a photoconductive sensor switch, as in U.S. Pat. No. 6,203,167. Timing circuits can also be used to turn off the light and provide a predetermined duration of illumination, as disclosed in U.S. Pat. No. 5,245,285.

Some of these devices use large components, such as incandescent lamps and size AA (Alkaline or Nickel-Cadmium) batteries, such that the devices are rather large and thus occupy storage space or are not readily positionable adjacent a pull-out drawer and the associated opening. Others require complex electronics or switching mechanisms. Thus, a more compact and simplified lighting device is desired.

### SUMMARY OF THE INVENTION

The present invention provides a convenience light having a battery powered LED lamp for illuminating small interior spaces of enclosures. A mechanical or magnetic switch device is used to automatically turn on and off the LED by opening and closing the movable member (drawer, door, etc.) of the enclosure. The low power consumption LED provides lengthy continuous use of the light with a tiny watch battery. The LED and watch battery allow the housing to have a small form factor for discrete placement in the enclosure at various positions. In variations forms, the device can include a reflective surface at the exterior of the housing adjacent the lamp and a mechanism to articulate the lamp for directional control of the illumination.

The advantages of the invention will be apparent from the detailed description and drawings. What follows is a preferred embodiment of the present invention. To assess the full scope of the invention the claims should be looked to as the preferred embodiment is not intended as the only embodiment within the scope of the invention.

### BRIEF DESCRIPTION OF THE DRAWINGS

FIG. 1 is a perspective view of a first embodiment of a convenience light of the present invention shown attached to a drawer in partial perspective;

FIG. 2 is an exploded perspective view of the convenience light;

FIG. 3 is a top interior view thereof;

FIG. 4 is partial side sectional view showing the drawer in a closed position and the convenience light with an LED not illuminated;

FIG. 5 is a similar view but showing the drawer in an open position and the convenience light with the LED illuminated;

FIG. 6 is bottom exterior view of the convenience light;

FIG. 7 illustrates another embodiment of the convenience light having a mechanism for articulating the lamp; and

FIG. 8 illustrates yet another embodiment of the convenience light having a spring biased operating member.

### DETAILED DESCRIPTION OF THE PREFERRED EMBODIMENTS

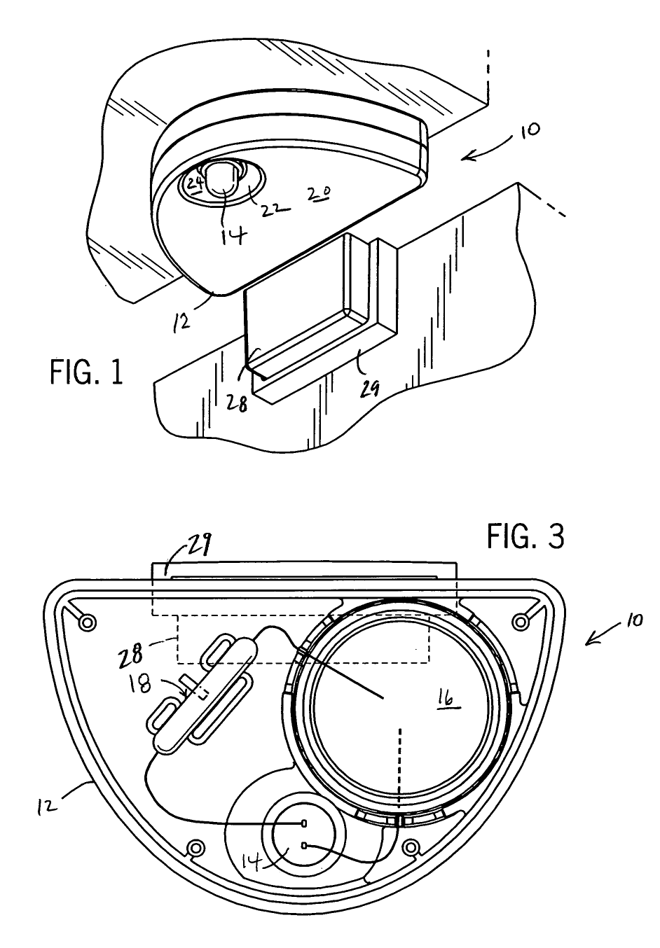

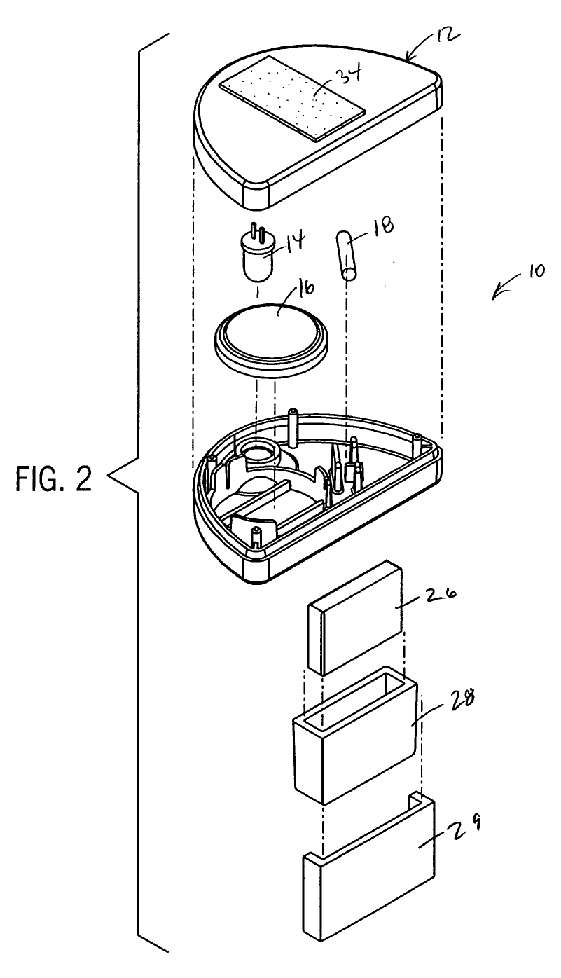

Referring to FIGS. 1-3 and 6, one preferred embodiment of the convenience light of the present invention is referred to generally by reference number 10. The convenience light 10 has a housing 12 primarily containing a lamp 14, a battery 16 and a switch 18. Associated electrical circuitry, as known in the art, may also be included as well as mounts and retainers for such components.

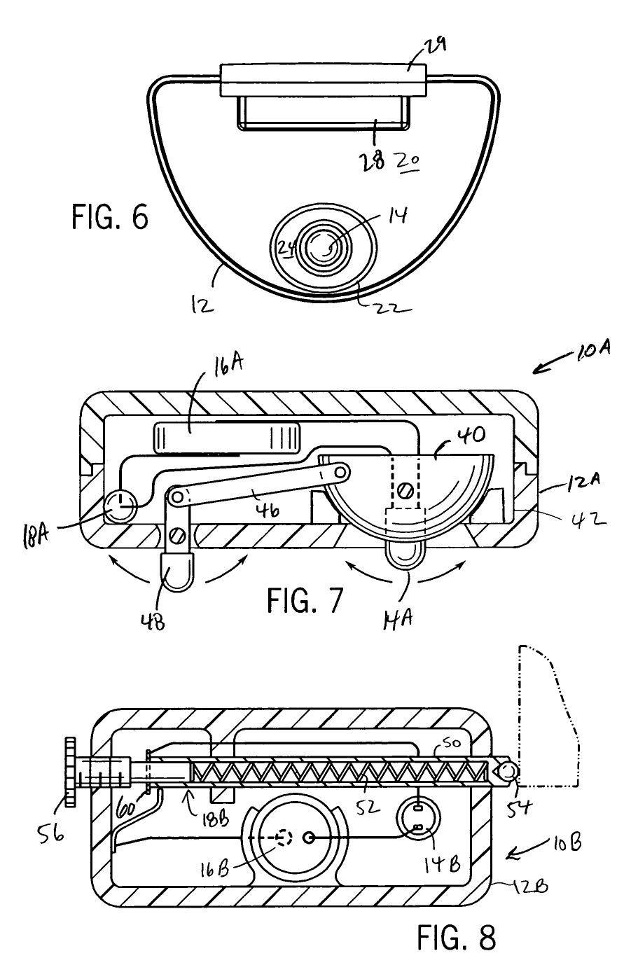

The housing 12 is preferably of plastic construction in a D-shape with a straight spine and a curved rear side and of approximate overall dimensions of 1¼″×1″×¼″. The housing 12 can be formed in two pieces and suitably sealed at the seam, for example by adhesive or sonic welding. As shown in FIGS. 1 and 6, the lower face 20 of the housing 12 has a dished area 22, which is an opening for the lamp 14 to project out from the housing 12. A reflective surface 24, either a reflector body or a reflective coating, is disposed in the dished area 22 to direct light from the lamp 14 out from the lower face 20 of the housing 12. The top or back face of the housing 12 can have a removable or hinged access panel (not shown), located to access the battery 16, thereby allowing it to be replaced should it become depleted.

The lamp 14 is preferably a 3.6 volt, 20 mA white LED, providing bright while light with low power consumption. The battery 16 is preferably a 3 volt, 950 mA flat disk lithium battery, of the type used in small electronics and watches. This combination of LED lamp and watch battery is expected to give more than 24 hours, and more closely 45 hours, of continuous use. When used in a typical drawer application in which the light is turned on for a few seconds intermittently, the device should give several years of operation without maintenance or replacement of either the lamp or battery. The switch 16 is preferably a Reed switch, of known construction, which typically includes ferromagnetic contact blades, hermetically sealed in a glass envelope filled with an inert gas. The switch 16 is operated by an externally generated magnetic field, either from a coil or permanent magnet 26, which causes movement of a contact to either complete or break the electrical path between the LED and the battery. The magnet 26 can be an adhesive backed magnetic strip, attached to the back side of the drawer front, as shown. Or, as shown in FIGS. 1, 2, and 4-6, the magnet 26 can be mounted in a sleeve-like holder 28 that either mounts directly to the drawer or to an appliqué 29. The applique 29 is preferably conformable to contours of the drawer surface common in antique furnishings on one side and generally flat at the other side to which the magnet holder 28 attaches. Double-sided adhesive or other suitable mounting methods can be used to affix the magnet holder 28 and the applique 29.

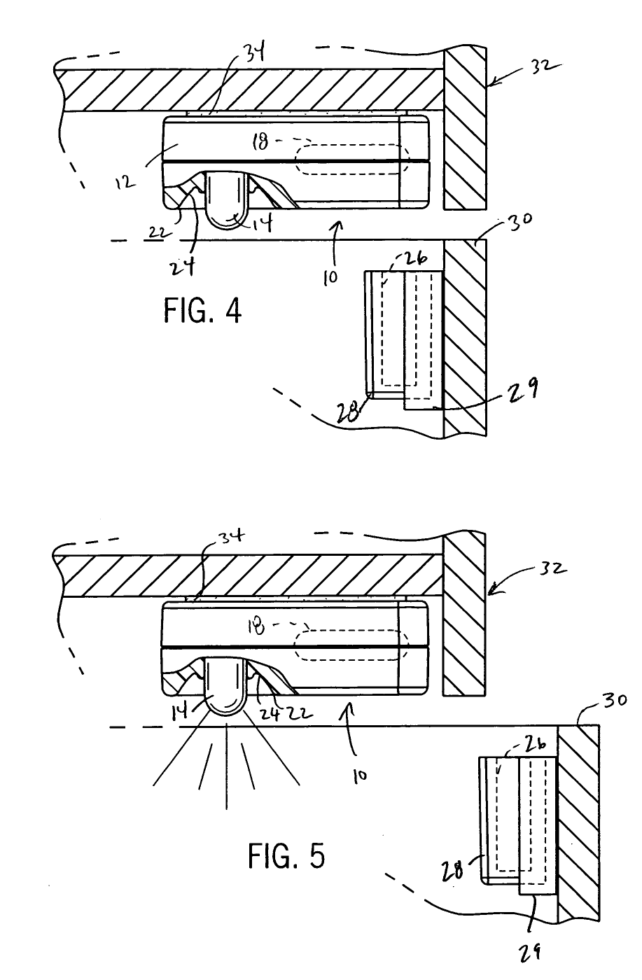

FIGS. 4 and 5 illustrate one application for the convenience light 10 of the present invention in which it is used to illuminate the interior of a pull out drawer 30 in a piece of furniture 32, such as a desk or beside stand. While shown in the drawings for illuminating a drawer, it should be understood that the convenience light 10 of the present invention can be used to illuminate the interior of any enclosure having a movable section. Thus, without limiting its use, other example enclosures include cabinets, chests, cupboards, jewelry and tool boxes, safes or other lockboxes, automobile compartments, and other such enclosures have a movable drawer, door, lid or cover.

The convenience light 10 can be mounted to the interior of the furniture 32 above the drawer 30 along its straight spine or along its upper face (as shown) using a suitable fastener member 34, such as double sided adhesive or Velcro®, for example. In this location, the light does not occupy any of the usable space in the drawer of the furniture. The convenience light 10 is positioned so that the Reed switch 18 is adjacent to, preferably slightly spaced from, the magnet 26. The Reed switch 18 is configured to be normally closed. When the drawer 30 is closed as in FIG. 4, the field from the magnet 26 opens the Reed switch 18 so that the lamp 14 is disconnected from the battery 16 and in an “off” state. When the drawer 30 is opened, as shown in FIG. 5, the Reed switch 18 is no longer affected by the magnetic field such that it returns to its normally closed position, thereby connecting the lamp 14 to the battery 16 and turning it “on”. In this way, the light automatically turns on when the drawer 30 is opened and shuts off when the drawer 30 is closed.

As mentioned, the electrical circuitry is not shown in the drawings as it is within the routine skill of designers of the electrical arts. If desired, timing circuitry can be included to turn off the lamp after a prescribed period of time in order to prevent the battery from draining if the drawer was left open for an extended time. A photo sensor could also be included, for example, to prevent the lamp from turning on when the drawer was opened and there was adequate ambient light to illuminate the inside of the drawer.

FIG. 7 illustrates another embodiment of the convenience light 10A. Like the previous embodiment, this version includes a housing 12A, a lamp 14A, a battery 16A and a switch 18A. However, here, the lamp 14A is designed to be articulated relative to the housing 12 so that the light can be directed to a specific location inside the enclosure. Specifically, the lamp 14A is mounted to a curved pivot block 40 with its convex, preferably low friction (e.g., Teflon®), outer surface mated with the concave recess of a lamp cradle 42 mounted to the housing 12A. A link assembly 44 includes link 46 connected to the pivot block 40 and lever 48 pivotally mounted in the housing 12A and projected to its exterior so that it can be manipulated when mounted inside the enclosure. Pivoting the lever 48 in turn pivots the lamp 14A by pivoting the pivot block 40 within the cradle 42. Because the mating surfaces of the pivot block 40 and cradle 42 are generally spherical, the lamp 14A can be pivoted through a range of angular positions. It should be noted that the lamp could be pivoted directly with a finger or thumb without using the link assembly 44.

FIG. 8 illustrates another embodiment of the convenience light 10B. Here, the housing 12B, lamp 14B and battery 16B are generally the same, but the switch 18B is a mechanical contact type switch of unique design and the housing is mounted to the interior front wall of the movable section (e.g., drawer). In particular, the switch 18B includes a tube 50 containing a spring 52 and capturing a ball 54 between the spring 52 and a narrowed, open outer end of the tube 50, which extends outside the housing 12B. A threaded thumb screw 56 at the other end of the tube 50 depresses the spring 52 to adjust the extension of the tube 50, and thereby provide fine tuning of the switch setting for different applications without having to readjust the mounting position of the housing 12B. When the ball 54, which rotates in the tube 50, contacts a surface of the enclosure or the movable section (as when opening a drawer), it depresses the tube 50 slightly into the housing 12B and so that contact 60 closes the circuit between the lamp 14B and battery 16B to turn on the lamp 14B. When the ball 54 is free of the enclosure surface (as when the drawer is closed), the contact 60 moves to open the circuit and turn off the lamp 14B.

It should be appreciated that merely preferred embodiments of the invention have been described above. However, many modifications and variations to the preferred embodiments will be apparent to those skilled in the art, which will be within the spirit and scope of the invention. Therefore, the invention should not be limited to the described embodiment. To ascertain the full scope of the invention, the following claims should be referenced.

1. A convenience light for illuminating the interior of an enclosure having a section movable between open and closed positions, the convenience light comprising:
a battery;
an LED lamp powered by the battery;
a switch electrically coupled to the battery and the lamp to control operation of the lamp; and
a housing containing the battery, the lamp and the switch and having an exterior mount for mounting to the enclosure interior;
wherein the housing is positionable in the enclosure such that the enclosure movable section can operate the switch to activate the lamp when the enclosure movable section is in the open position and de-activate the lamp when the enclosure movable section is in the closed position.

2. The convenience light of claim 1, wherein the battery and lamp provide at least 24 hours of continuous operation.

3. The convenience light of claim 2, wherein the battery and lamp provide approximately 45 hours or more of continuous operation.

4. The convenience light of claim 1, wherein the switch is operated without contact by the enclosure movable section.

5. The convenience light of claim 4, wherein the switch is a magnetic switch.

6. The convenience light of claim 5, further including a magnet mounted to an interior surface of the enclosure movable section.

7. The convenience light of claim 1, wherein the switch is a mechanical switch.

8. The convenience light of claim 7, wherein the switch includes a tube member containing a spring rotatably capturing a ball member between a narrowed end of the tube member extending to an exterior of the housing for contact with an interior surface of the enclosure or enclosure movable member.

9. The convenience light of claim 8, wherein switch further includes an adjustment member for adjusting the extension of the tube member relative to the housing.

10. The convenience light of claim 9, wherein the adjustment member is a thumb screw bearing against the spring.

11. The convenience light of claim 1, wherein the housing is D-shaped.

12. The convenience light of claim 1, further including a reflective surface disposed on an exterior of the housing adjacent the lamp.

13. The convenience light of claim 1, wherein the housing has an inwardly dished surface about an opening receiving the lamp.

14. The convenience light of claim 13, further including a reflective surface disposed on the dished surface of the housing.

15. The convenience light of claim 1, further including a mechanism for articulating the lamp.

16. The convenience light of claim 15, wherein the mechanism is a linkage assembly having a pivotal lever extending to an exterior of the housing.

17. The convenience light of claim 16, further including a curved lamp support pivotally received in a lamp cradle fixed to the housing.

18. The convenience light of claim 1, wherein the housing is no more than approximately ¼ inch thick.

19. The convenience light of claim 1, wherein the enclosure is selected from the group consisting of: furniture, cabinets, lockboxes, chests and cupboards.

20. The convenience light of claim 1, wherein the enclosure movable section is selected from the group consisting of: drawers, lids and doors.
